(19) United States
(12) Patent Application Publication
(10) Pub. No.: US 2014/0319748 A1
(43) Pub. Date: Oct. 30, 2014

(54) ASSEMBLY OF A SEMI-FINISHED LENS WITH A PRISMATIC HOLDING BLOCK AND METHOD FOR PRODUCING SAME

(71) Applicant: SHAMIR OPTICAL INDUSTRY LTD., Kibbutz Shamir (IL)

(72) Inventors: Haim HAINEBACH, Kibbutz Shamir (IL); Dan KATZMAN, Givat Ela (IL); Zohar KADMON, Kibbutz Shamir (IL)

(73) Assignee: Shamir Optical Industry Ltd., Kibbutz Shamir (IL)

(21) Appl. No.: 13/871,139

(22) Filed: Apr. 26, 2013

(51) Int. Cl. B25B 11/02

(52) U.S. Cl. CPC B25B 11/02
USPC 269/55; 269/309; 156/60; 156/349

(57) ABSTRACT

A pre-production assembly of a semi-finished ophthalmic lens with a prismatic holding block and a method for producing such pre-production assembly, the method may include receiving as input pre-collected data about typical values of calculated prism for lens with different parameters; and according to the received input, producing a pre-production assembly of semi-finished ophthalmic lens with prismatic holding block. The pre-production assembly may include a semi-finished ophthalmic lens having one face finished with a base curvature; and a block assembly attached to the finished face of said lens, the block assembly having a connector to mount the semi-finished lens on a processing device and an adhesive layer adhering the block assembly to the finished face of the lens, the block assembly having a prism value determined according to lens parameters and the pre-collected data about typical values of calculated prism for lens with different parameters.

### BACKGROUND OF THE INVENTION

Late technology of lens production may enable specific lens designs for different wearers, environments and activities. Multifocal lens may provide different optical power regions in different locations on the lens. According to some methods, the lens may include a substantially continuous change of optical power along the lens, so that a specific topography of the lens is produced according to various variables. Production of such lenses may involve a sophisticated computerized surfacing tool that may cut a lens surface very accurately according to a specific lens prescription.

Accordingly, production of lenses may be a very delicate process because of the accuracy required in order to follow the designed surface topography and avoid vision distortions. As the topography changes are greater, the surfacing tool may need to move very quickly and accurately in the perpendicular direction. In some methods, the lens may be produced with added prism, e.g. held in an angle relative to the surfacing tool in order to reduce the movement amplitude and/or amplitude changes required from the surfacing tool. Failure to perform the movement of the surfacing tool accurately and/or to synchronize the movement properly may cause distortions in the lens topography and vision distortions. Methods that may reduce the movement amplitude and/or amplitude changes required from the surfacing tool may prevent such inaccuracies.

Additionally, prism may be added to a lens in order to provide a better, for example, thinner, design and/or in order to cure certain sight disorders.

### SUMMARY OF THE INVENTION

Embodiments of the present invention may provide a pre-production assembly of a semi-finished ophthalmic lens with a prismatic holding block, the pre-production assembly may include a semi-finished ophthalmic lens having one face finished with a base curvature; and a block assembly attached to the finished face of said lens, the block assembly having a connector to mount the semi-finished lens on a processing device and an adhesive layer adhering the block assembly to the finished face of said lens, the block assembly having a prism value determined according to the base curvature of the semi-finished ophthalmic lens. The prism value may be further determined according to at least one of refractive index and design of said semi-finished ophthalmic lens. The prism value may be provided by an inclination included in the adhesive layer and/or the connector and/or more specifically a base support portion included in said connector.

According to some embodiments of the present invention, the connector may include a adapter portion to enable holding of the pre-production assembly by a processing machine; and a base support portion to which the semi-finished ophthalmic lens is adhered. When mounted on a processing machine, the pre-production assembly may be rotated about an axis passing through a center of the adapter, wherein the rotation may be controlled by the processing machine.

Additionally, embodiments of the present invention may provide a method for producing a pre-production assembly of a semi-finished ophthalmic lens with a prismatic holding block, the method may include receiving as input pre-collected data of correspondence between certain values of base curvatures and typical corresponding values of added prism; and according to the received input, producing a pre-production assembly of semi-finished ophthalmic lens with prismatic holding block according to embodiments of the present invention.

Additionally, embodiments of the present invention may provide a system for producing a pre-production assembly of a semi-finished ophthalmic lens with a prismatic holding block, the system may include a computer to receive as input pre-collected data of correspondence between certain values of base curvatures and typical corresponding values of added prism; and a pre-production machine to produce, according to the received input, a pre-production assembly of semi-finished ophthalmic lens with prismatic holding block according to embodiments of the present invention.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a surfacing machine for lens production that may use pre-production assembly of a semi-finished ophthalmic lens with a holding block according to embodiments of the present invention;

FIG. 2 is a schematic illustration of a system for producing a pre-production assembly of a semi-finished ophthalmic lens with a holding block according to embodiments of the present invention;

FIGS. 3A-3C are schematic illustrations of pre-production assemblies of semi-finished ophthalmic lenses with prismatic holding blocks according to various embodiments of the present invention;

FIG. 4 is an exemplary diagram illustrating an exemplary processed set of data showing correspondence between certain values of base curvatures and typical corresponding values of added prism; and

FIG. 5 is a schematic flowchart illustrating a method for producing a pre-production assembly of semi-finished ophthalmic lens with prismatic holding block according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

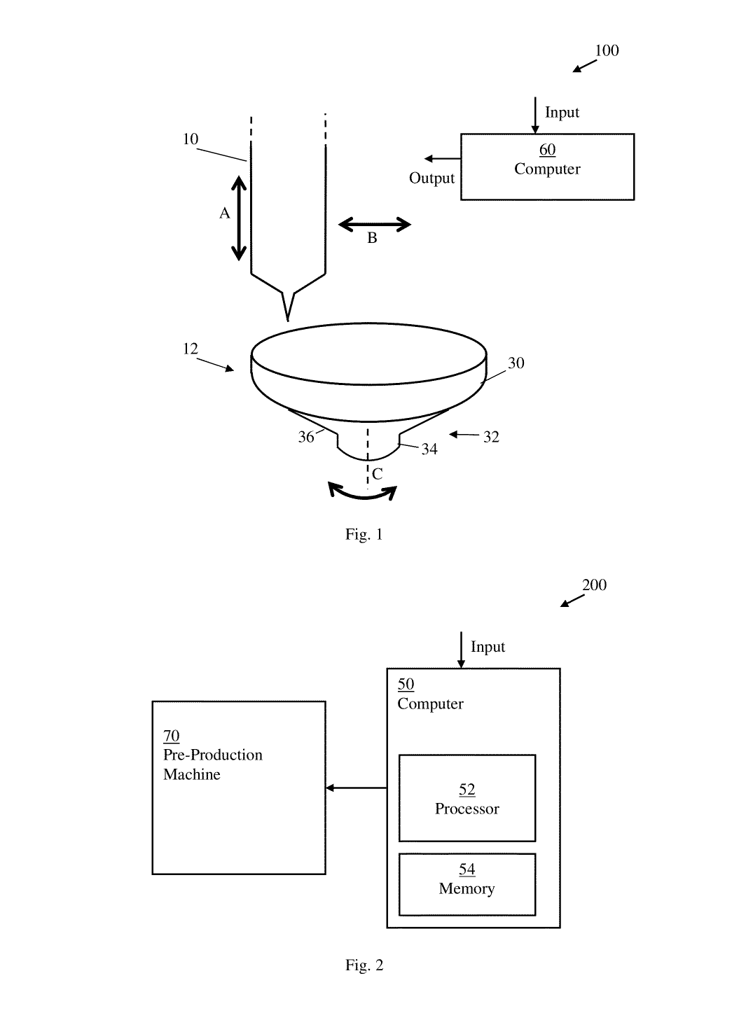

Reference is now made to FIG. 1, which is a schematic illustration of a surfacing machine 100 for lens production that may use pre-production assembly 12 of a semi-finished ophthalmic lens 30 with a holding block 32 according to embodiments of the present invention. Surfacing machine 100 may include a computer 60, a surfacing tool 10 and a mount (not shown) to hold a pre-production assembly 12 of semi-finished ophthalmic lens 30 with holding block 32. Holding block 32 may be used for mounting assembly 12 on surfacing machine 100. Holding block 32 may include an adapter portion 34, by which assembly 12 may be held by surfacing machine 100, and a base support portion 36, to which semi-finished ophthalmic lens 30 may be adhered. When mounted on surfacing machine 100, assembly 12 may be rotated about an axis C passing through a center (for example, a hub) of adapter 34, for example in a direction and/or speed controlled by surfacing machine 100.

Computer 60 may receive input including, for example, lens prescription, and may provide instructions to surfacing machine 100. Surfacing machine 100 may activate surfacing tool 10 to move forward and backward, e.g. move along axis A, which may be substantially parallel to axis C. By this movement, surfacing machine 100 may determine the depth of the cutting of semi-finished ophthalmic lens 30 by surfacing tool 10. Additionally, surfacing machine 100 may activate surfacing tool 10 to move sideward, e.g. in a radial direction towards and away from the center of semi-finished ophthalmic lens 30, e.g. move along axis B, which may be substantially perpendicular to axis C and/or pass substantially through the center of semi-finished ophthalmic lens 30. By this movement, and by controlling the rotation of assembly 12, surfacing machine 100 may determine the location of the cutting by surfacing tool 10 on the surface of semi-finished ophthalmic lens 30.

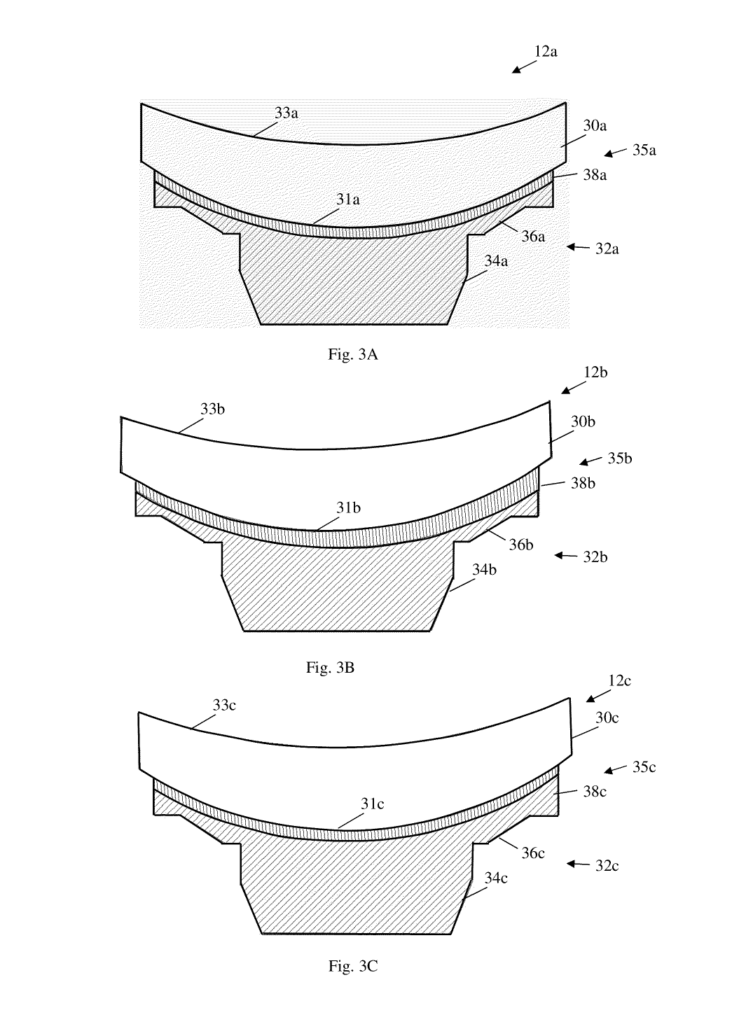

In order to produce certain prescribed lens surfaces by surfacing machine 100, an added prism inclination may be required and/or desired, for example in order to produce a better and/or required lens design and/or to reduce the operational range required from surfacing tool 10, for example especially in axis A, e.g. forward and backward movement towards and away from the depth of semi-finished ophthalmic lens 30. According to embodiments of the present invention, the prism inclination may be obtained by including a pre-determined prism inclination in a pre-produced pre-production assembly 12, as shown, for example, in FIGS. 3B and 3C described herein below, for example in base support 36 or in the adhesive layer (shown in FIGS. 3A-3C) that adhere semi-finished ophthalmic lens 30 to holding block 32. When a prism inclination is included in pre-production assembly 12, an inverse prism inclination is obtained in the produced lens surface by surfacing machine 100.

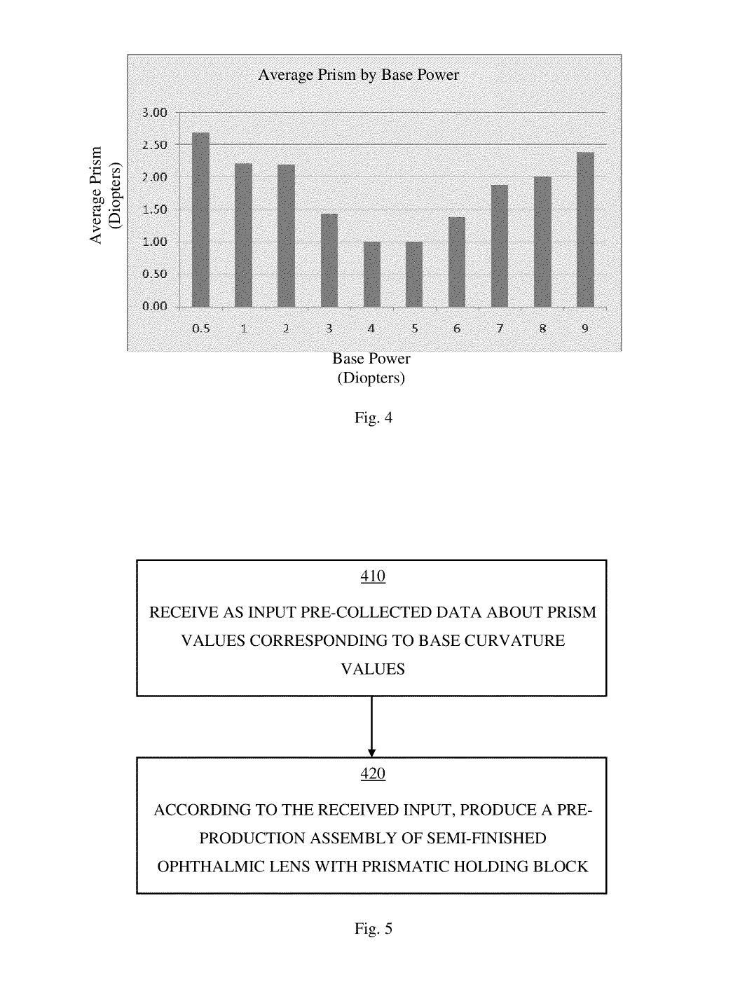

Semi-finished lens are typically produced with one face of the lens that have a base curvature, e.g. providing the lens with a base optical power, while added power and/or other prescribed optical topographies such as an added cylinder power and/or prism power etc. are produced on the second face of the lens. According to embodiments of the present invention, the base curvature may be determined according to, for example, the required effective total lens power, lens material, lens design, and/or other suitable parameters. Typically, lenses that are produced with certain values of base curvatures according to various parameters are also produced with certain corresponding values of added prism, for example in order to obtain a better lens design, vision clarity and/or in order to require a smaller operational range of the surfacing tool, which may increase the accuracy of production. The diagram in FIG. 4 illustrates an exemplary processed set of data showing correspondence between certain values of base curvatures and typical corresponding values of added prism. Such data may be collected, for example, from lens production sites, eye physicians, optometrists, opticians etc. and processed according to embodiments of the present invention in order to produce a set of data that may show correspondence between certain values of base curvatures and typical corresponding values of added prism. Similarly, data may be obtained about the correspondence between typical added prism values and the lens material being used (i.e., the refractive index of the material), between typical added prism values and the lens design and between typical added prism values and other suitable parameters.

Reference is now made to FIG. 2, which is a schematic illustration of a system 200 for producing a pre-production assembly of a semi-finished ophthalmic lens with a holding block according to embodiments of the present invention. System 200 may include a computer 50 and pre-production machine 70. Computer 50 may include a processor 52 and a memory 54. Memory 54 may include an article such as a computer or processor readable non-transitory storage medium, such as for example a memory, a disk drive, or a USB flash memory encoding, including or storing instructions, e.g., computer-executable instructions, which when executed by a processor or controller, cause the processor or controller to carry out methods disclosed herein.

Computer 50 may receive as input pre-collected data of typical values of calculated prism for lens with different base curvatures and/or parameters that may affect determination of base curvature such as, for example, refractive index and/or lens design and/or other suitable parameters. For example, the pre-collected data may be about correspondence between certain values of base curvatures, refractive index and/or lens design and typical corresponding values of added prism. An exemplary diagram illustrating such pre-collected data is shown in FIG. 4 described herein. The data may include, for example, average prism values that are typically used with certain base curvature values. According to the received input, computer 50 may provide instructions to pre-production machine 70 that may produce a pre-production assembly of semi-finished ophthalmic lens with prismatic holding block. As described in detail below with reference to FIGS. 3A-3C, the produced pre-production assembly may include a semi-finished ophthalmic lens having one face finished with a base curvature, and a prismatic block assembly attached to the finished face of said lens, the prismatic block assembly may have a prism value determined according to the base curvature, refractive index, and/or design of the semi-finished ophthalmic lens. The block assembly may include a connector such as, for example, holding block 32 to mount said semi-finished lens on a processing device such as, for example, surfacing machine 100 and adhesive layer that may adhere the block assembly to the finished face of the semi-finished lens. Since there are typical values of calculated prism for certain base curvatures, refractive indexes and design, the produced pre-production assemblies may be utilized for most of the produced lenses and only a small number of especially designed holding blocks may be required.

Reference is now made to FIGS. 3A-3C, which are schematic illustrations of pre-production assemblies 12a, 12b and 12c of semi-finished ophthalmic lenses 30a, 30b and 30c with holding blocks 32a, 32b and 32c according to various embodiments of the present invention. Pre-production assemblies 12a, 12b and 12c may be produced by pre-production machine 70 according to instructions received from computer 50. As discussed herein, embodiments of the present invention may provide pre-produced assemblies of semi-finished ophthalmic lenses with corresponding prismatic holding blocks according to pre-collected data about base curvatures, refractive indexes and/or design of the semi-finished ophthalmic lens and typical corresponding prism values. As described above with reference to FIG. 1, holding blocks 32a , 32b and 32c may include adapter portions 34a, 34b and 34c, respectively, by which assemblies 12a, 12b and 12c may be held by a processing machine, and base support portions 36a, 36b and 36c, respectively, to which semi-finished ophthalmic lenses 30a, 30b and 30c may be adhered, respectively. When mounted on a processing machine such as, for example, surfacing machine 100, assembly 12a, 12b or 12c may be rotated about an axis passing through a center (for example, a hub) of adapter 34a, 34b or 34c, respectively, for example an axis C as shown in FIG. 1, for example in a direction and/or speed controlled by surfacing machine 100. As discussed below, in various embodiments, base support portions 36a, 36b and/or 36c may include an inclination, i.e. a prism value.

As shown in FIG. 3A, a pre-production assembly 12a may include a semi-finished lens 30a with a certain base curvature on a finished face 31a. Semi-finished lens 30a may include an un-finished face 33a that, for example, may have to be further processed by a processing tool such as, for example, surfacing machine 100. Additionally, as shown in FIG. 3A, a pre-production assembly 12a may include a block assembly 35a, substantially without added prism, attached to finished face 31a of lens 30a. Block assembly 35a may include a connector or holding block 32a, for example to mount semi-finished lens 30a on a processing device such as, for example, surfacing machine 100, and adhesive layer 38a adhering block assembly 35a to finished face 31a of lens 30a. Block assembly 35a may substantially have no prism value as may be determined, for example, according to the base curvature, refractive index and/or design of semi-finished ophthalmic lens 30a, for example as may be produced by pre-production machine 70 according to instructions received from computer 50.

As shown in FIG. 3B, a pre-production assembly 12b may include a semi-finished lens 30b with a certain base curvature on a finished face 31b. Semi-finished lens 30b may include an un-finished face 33b that, for example, may have to be further processed by a processing tool such as, for example, surfacing machine 100. Additionally, as shown in FIG. 3B, a pre-production assembly 12b may include a prismatic block assembly 35b attached to finished face 31b of lens 30b. Prismatic block assembly 35b may include a connector or holding block 32b, for example to mount semi-finished lens 30b on a processing device such as, for example, surfacing machine 100, and adhesive layer 38b adhering block assembly 35b to finished face 31b of lens 30b. As shown in FIG. 3B, adhesive layer 38b may include a certain inclination. i.e. a prism value. Base support portion 36b may or may not include an additional prism value. The prism value of adhesive layer 38b, possibly together with an additional prism value of base support portion 36b, may provide block assembly 35a with a prism value that may be determined, for example, according to the base curvature, refractive index and/or design of semi-finished ophthalmic lens 30b, for example as may be produced by pre-production machine 70 according to instructions received from computer 50.

As shown in FIG. 3C, a pre-production assembly 12c may include a semi-finished lens 30c with a certain base curvature on a finished face 31c. Semi-finished lens 30c may include an un-finished face 33c that, for example, may have to be further processed by a processing tool such as, for example, surfacing machine 100. Additionally, as shown in FIG. 3C, a pre-production assembly 12c may include a prismatic block assembly 35c attached to finished face 31c of lens 30c. Prismatic block assembly 35c may include a connector or holding block 32c, for example to mount semi-finished lens 30c on a processing device such as, for example, surfacing machine 100, and adhesive layer 38c adhering block assembly 35c to finished face 31c of lens 30c. As shown in FIG. 3C, base support portion 36c may include a certain inclination, i.e., a prism value. Adhesive layer 38c may or may not include an additional prism value. The prism value of base support portion 36c, possibly together with an additional prism value of adhesive layer 38c, may provide block assembly 35c with a prism value that may be determined, for example, according to the base curvature, refractive index and/or design of semi-finished ophthalmic lens 30c, for example as may be produced by pre-production machine 70 according to instructions received from computer 50.

Since there are typical values of calculated prism for certain base curvatures, refractive indexes and/or lens designs, the produced pre-production assemblies may be utilized for most of the produced lenses and only a small number of especially designed holding blocks may be required. Various produced pre-production assemblies according to embodiments of the present invention, with prism values corresponding to the base curvatures, refractive indexes and/or lens designs, may be provided according to embodiments of the present invention and used for lens production without the need to produce an especially designed holding block for each prescription separately.

Reference is now made to FIG. 5, which is a schematic flowchart illustrating a method for producing a pre-production assembly of semi-finished ophthalmic lens with prismatic holding block according to embodiments of the present invention. As indicated in block 410 the method may include receiving as input pre-collected data of correspondence between certain values of base curvatures and typical corresponding values of added prism, for example as described in detail herein above. As indicated in block 420 the method may include producing a pre-production assembly of semi-finished ophthalmic lens with prismatic holding block according to the received input, for example as described in detail herein above. As described herein above, the pre-production assembly may include a semi-finished ophthalmic lens having one face finished with a base curvature, and a block assembly attached to the finished face of the lens. The block assembly may include a connector to mount the semi-finished lens on a processing device and an adhesive layer adhering the block assembly to the finished face of said lens. The block assembly may have a prism value determined according to the base curvature of the semi-finished ophthalmic lens.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A pre-production assembly of a semi-finished ophthalmic lens with a prismatic holding block, said pre-production assembly comprising:
a semi-finished ophthalmic lens having one face finished with a base curvature; and
a block assembly attached to the finished face of said lens, said block assembly having a connector to mount said semi-finished lens on a processing device and an adhesive layer adhering said block assembly to said finished face of said lens, said block assembly having a prism value determined according to lens parameters and pre-collected data about typical values of calculated prism for lens with different parameters.

2. The pre-production assembly according to claim 1, wherein said connector comprises:
a adapter portion to enable holding of said pre-production assembly by a processing machine; and
a base support portion to which the semi-finished ophthalmic lens is adhered.

3. The pre-production assembly according to claim 2, wherein when mounted on a processing machine, said pre-production assembly is rotatable about an axis passing through a center of said adapter, wherein the rotation is controlled by said processing machine.

4. The pre-production assembly according to claim 1, wherein said prism value is provided by an inclination included in the adhesive layer.

5. The pre-production assembly according to claim 1, wherein said prism value is provided by an inclination included in the connector.

6. The pre-production assembly according to claim 2, wherein said prism value is provided by an inclination included in the base support portion.

7. The pre-production assembly according to claim 1, wherein said parameters include at least one of base curvature, refractive index and design of said semi-finished ophthalmic lens.

8. A method for producing a pre-production assembly of a semi-finished ophthalmic lens with a prismatic holding block, said method comprising:
receiving as input pre-collected data about typical values of calculated prism for lens with different parameters; and
according to the received input, producing a pre-production assembly of semi-finished ophthalmic lens with prismatic holding block, said pre-production assembly comprising:
a semi-finished ophthalmic lens having one face finished with a base curvature; and
a block assembly attached to the finished face of said lens, said block assembly having a connector to mount said semi-finished lens on a processing device and an adhesive layer adhering said block assembly to said finished face of said lens, said block assembly having a prism value determined according to lens parameters and the pre-collected data about typical values of calculated prism for lens with different parameters.

9. The method according to claim 8, wherein said connector comprises:
a adapter portion to enable holding of said pre-production assembly by a processing machine; and
a base support portion to which the semi-finished ophthalmic lens is adhered.

10. The method according to claim 8, wherein said prism value is provided by an inclination included in the adhesive layer.

11. The method according to claim 8, wherein said prism value is provided by an inclination included in the connector.

12. The method according to claim 9, wherein said prism value is provided by an inclination included in the base support portion.

13. The method according to claim 8, wherein said parameters include at least one of base curvature, refractive index and design of said semi-finished ophthalmic lens.

14. A system for producing a pre-production assembly of a semi-finished ophthalmic lens with a prismatic holding block, said system comprising:
a computer to receive as input pre-collected data about typical values of calculated prism for lens with different parameters; and
a pre-production machine to produce, according to the received input, a pre-production assembly of semi-finished ophthalmic lens with prismatic holding block, said pre-production assembly comprising:
a semi-finished ophthalmic lens having one face finished with a base curvature; and
a block assembly attached to the finished face of said lens, said block assembly having a connector to mount said semi-finished lens on a processing device and an adhesive layer adhering said block assembly to said finished face of said lens, said block assembly having a prism value determined according to lens parameters and the pre-collected data about typical values of calculated prism for lens with different parameters.

15. The system according to claim 14, wherein said connector comprises:
a adapter portion to enable holding of said pre-production assembly by a processing machine; and
a base support portion to which the semi-finished ophthalmic lens is adhered.

16. The system according to claim 14, wherein said prism value is provided by an inclination included in the adhesive layer.

17. The system according to claim 14, wherein said prism value is provided by an inclination included in the connector.

18. The system according to claim 15, wherein said prism value is provided by an inclination included in the base support portion.

19. The system according to claim 14, wherein said parameters include at least one of base curvature, refractive index and design of said semi-finished ophthalmic lens.
